(19) United States
(12) Patent Application Publication
(10) Pub. No.: US 2024/0126582 A1
(43) Pub. Date: Apr. 18, 2024

(54) DISASTER RECOVERY OF CONTAINERIZED WORKLOADS

(71) Applicant: VMware, Inc., Palo Alto, CA (US)

(72) Inventors: Pradeep Shanmukha JIGALUR, Bangalore (IN); Christopher John Schaefer, Venice, FL (US)

(21) Appl. No.: 17/965,612

(22) Filed: Oct. 13, 2022

(51) Int. Cl. G06F 9/455; G06F 11/20

(52) U.S. Cl. CPC G06F 9/45558; G06F 11/2033

(57) ABSTRACT

The disclosure provides a method for disaster recovery of a containerized workload running on a first host cluster. The method generally includes prior to determining the containerized workload is unreachable at the first host cluster: obtaining a current state of the containerized workload indicating a number of instances of the containerized workload that are running on the first host cluster; storing one or more images associated with the containerized workload on a second host cluster; and configuring the containerized workload at the second host cluster using the obtained current state without launching the containerized workload at the second host cluster; determining the containerized workload is unreachable; and instantiating instances of the containerized workload in the second host cluster using the stored one or more images, a number of the instances being based on the number of instances of the containerized workload that were running on the first host cluster.

Modern applications are applications designed to take advantage of the benefits of modern computing platforms and infrastructure. For example, modern applications can be deployed in a multi-cloud or hybrid cloud fashion, such as, consuming both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads run on a container orchestration platform that enables the automation of much of the operational effort required to run containers having workloads and services. This operational effort includes a wide range of things needed to manage a container's lifecycle, including, but not limited to, provisioning, deployment, scaling (up and down), networking, and load balancing. Kubernetes® (K8S)® software is an example open-source container orchestration platform that automates the operation of such containerized workloads.

In some cases, container orchestration software may support zero-downtime updates of the containerized workloads. In particular, users expect their applications to be available at all times; however, developers are also expected to deploy new versions of these applications, sometimes several times a day. In some cases, to allow for both to occur, container orchestration platforms may support a rolling update strategy used to allow updates to take place with zero downtime by incrementally updating pods with new ones.

However, while container orchestration software may allow for zero downtime updates, service interrupting events are inevitable and may occur at any time. For example, an outage and/or hardware failure may occur, there may be a loss of power due to, for example, a natural disaster, and/or data breaches and/or ransomware attacks may transpire, to name a few. Irrespective of such events, users may demand reliable and resilient operations. Accordingly, having a robust disaster recovery service for containerized workloads may be necessary.

It should be noted that the information included in the Background section herein is simply meant to provide a reference for the discussion of certain embodiments in the Detailed Description None of the information included in this Background should be considered as an admission of prior art.

### SUMMARY

One or more embodiments provide a method for disaster recovery of a containerized workload running on a first host cluster. The method generally includes prior to determining the containerized workload is unreachable at the first host cluster: obtaining a current state of the containerized workload running on the first host cluster, the current state indicating a number of instances of the containerized workload that are running on the first host cluster; storing one or more images associated with the containerized workload on a second host cluster; and configuring the containerized workload at the second host cluster using the obtained current state without launching the containerized workload at the second host cluster, the configuring comprising storing, at the second host cluster, an indication of the number of instances of the containerized workload that are running on the first host cluster; determining the containerized workload is unreachable at the first host cluster; and instantiating one or more instances of the containerized workload in the second host cluster using the stored one or more images in response to determining the containerized workload is unreachable at the first host cluster, a number of the one or more instances being based on the number of instances of the containerized workload that were running on the first host cluster.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A illustrates a computing system in which embodiments described herein may be implemented.

FIG. 1B illustrates an example cluster for running containerized workloads in the computing system of FIG. 1A, according to an example embodiment of the present disclosure.

FIG. 2 illustrates example operations for backup and restore of cluster resources, according to an example embodiment of the present disclosure.

FIG. 3 illustrates example operations for disaster recovery of containerized workloads, according to an example embodiment of the present disclosure.

FIG. 4 is a flow diagram illustrating example operations for instantiation of containerized workloads in a secondary cluster, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides techniques for disaster recovery of containerized workloads that reduce time to recovery in case of an event, such as infrastructure loss, data corruption, and/or services outages. For example, to provide a robust disaster recovery service for containerized workloads, backup and restore techniques are used. In certain aspects, incremental backup techniques may be used to capture the change, since a previous backup activity was conducted, in the state of resources of a cluster of interconnected nodes used to run containerized workloads at a first site. A node may be a physical machine, or a virtual machine (VM) configured to run on a physical machine running a hypervisor. Further, incremental restore techniques may be used to prepare these resources at a second site, in accordance with the change, such that when an event occurs at the first site, the resources may be used to continue operations at the second site. Certain aspects are discussed using incremental backup and restore techniques, but it should be understood that full backup and restore techniques may be used where all data is backed up and restored each time, instead of just changed data since a previous backup/restore.

In other words, incremental backup and restore techniques described herein may be used to frequently (e.g., continuously and/or periodically) determine the change to a state of a primary cluster at a first site, since a previous backup activity was conducted, and modify the state of a secondary cluster at a second site, such that the state of the secondary cluster is consistent with the current state of the primary cluster. In certain aspects, modifying the state of the secondary cluster involves modifying a configuration file for the secondary cluster to update system infrastructure and/or workloads of the secondary cluster such that a state of the workloads deployed on the secondary cluster match the state of the workloads deployed on the primary cluster.

Using incremental backup and restore techniques to frequently backup and restore workloads of the cluster at the second site, as described herein, may allow for nearly zero recovery time objective (RTO) and/or recovery point objective (RPO) when disaster recovery is performed as the result of an event. In particular, RTO is a measure of how much time it takes to restore normal operations after an event, while RPO refers to how much data loss is tolerable after an event. Given backup and restore is performed more frequently with incremental backup and restore techniques, the size of the backup may be drastically reduced when an event occurs thereby reducing both RTO and RPO to nearly zero when restoring workload(s) on the secondary site.

Further, by having resources for the workloads already prepared at the second site for running workloads on the second site when an event occurs at the first site, RTO and/or RPO may also be reduced. For example, in existing solutions, restoration of workload resources may occur only when an event happens. During the restore, pod and/or container images may need to be obtained from a repository before they can be instantiated on the second site for running workloads that have failed on the first site. Obtaining images from the repository may take additional time thereby increasing, at least, the RTO. Alternatively, with the incremental restore techniques described herein, pod and/or container images are frequently stored on the second site. Accordingly, when an event occurs, obtaining pod and/or container images from the repository may not be necessary prior to instantiating the workload on the second site leading to reduced RPO and/or RTO.

In addition to incremental backup and restore techniques, the present disclosure also introduces a cloud native load balancer that may be used to automate disaster recovery services for containerized workloads. Implementing an automated process for disaster recovery may help to minimize human intervention, thereby resulting in more efficient recovery of normal operations at the secondary site, as well as help to ensure consistency of data between the first site and the secondary site. As such, disaster recovery parameters, including RTO and/or RPO may be reduced should an event occur.

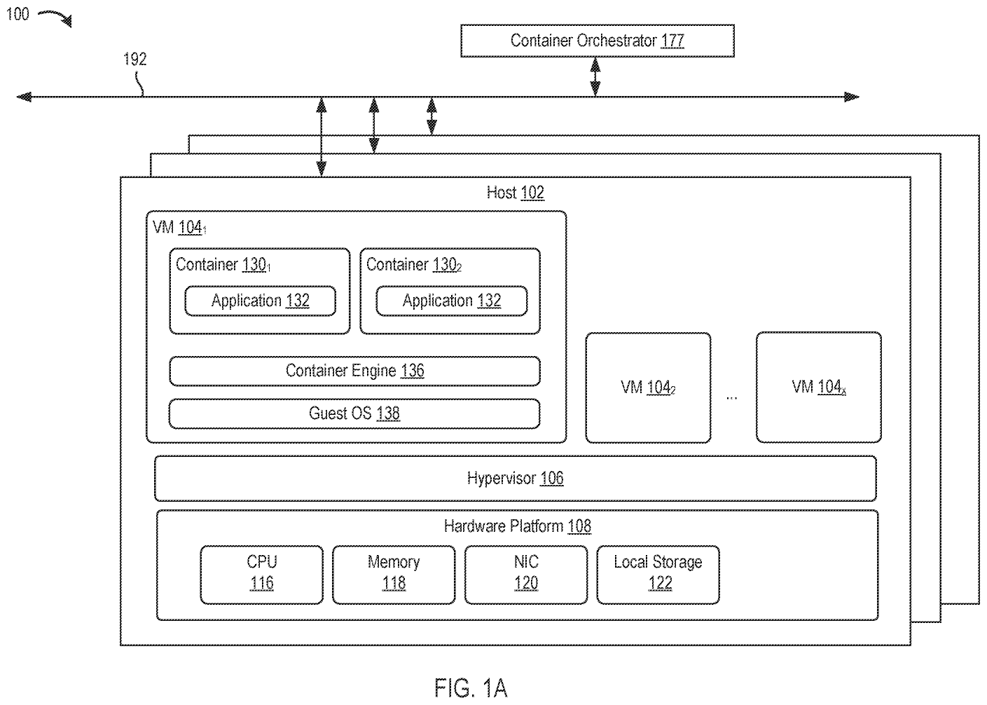

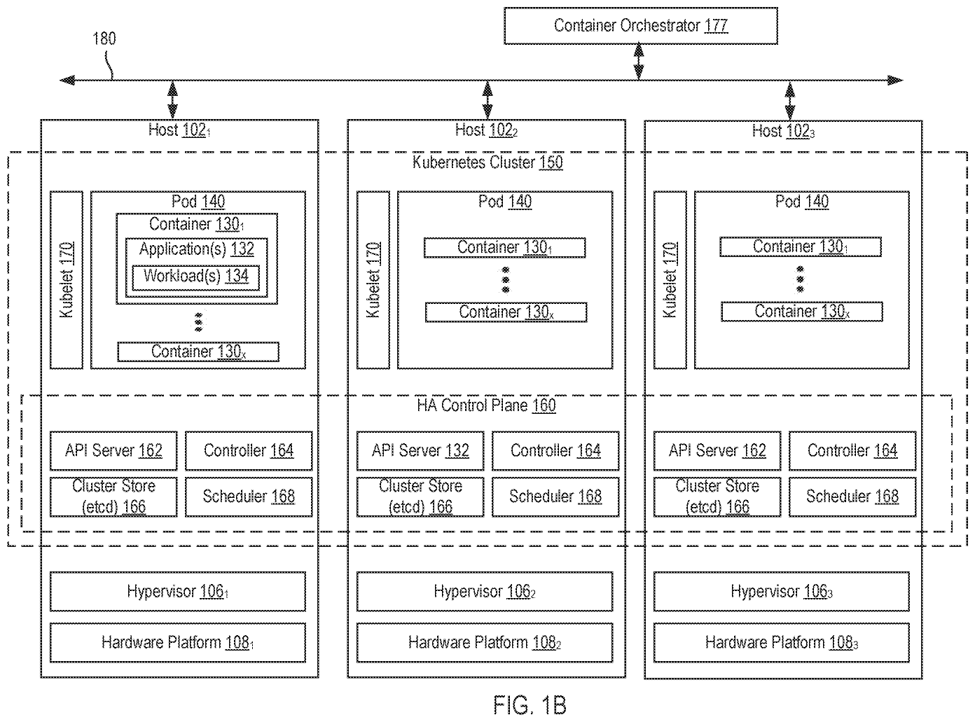

FIG. 1A is a block diagram that illustrates a computing system 100 in which embodiments described herein may be implemented. Computing system 100 includes one or more hosts 102 connected by a physical network 192. In particular, physical network 192 enables communication between hosts 102, and/or between other components and hosts 102.

Hosts 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104N (collectively referred to as VMs 104 and individually referred to as VM 104) that run concurrently on the same host 102.

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and in storage 122.

In certain aspects, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 106 implements one or more logical entities, such as logical switches, routers, etc. as one or more virtual entities such as virtual switches, routers, etc. In some implementations, hypervisor 106 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Each VM 104 implements a virtual hardware platform that supports the installation of a guest OS 138 which is capable of executing one or more applications. Guest OS 138 may be a standard, commodity operating system. Examples of a guest OS include Microsoft Windows, Linux, and/or the like.

In certain embodiments, each VM 104 includes a container engine 136 installed therein and running as a guest application under control of guest OS 138. Container engine 136 is a process that enables the deployment and management of virtual instances (referred to interchangeably herein as “containers”) by providing a layer of OS-level virtualization on guest OS 138 within VM 104. Containers 130₁ to 130_{Y} (collectively referred to as containers 130 and individually referred to as container 130) are software instances that enable virtualization at the OS level. That is, with containerization, the kernel of guest OS 138, or an OS of host 102 if the containers are directly deployed on the OS of host 102, is configured to provide multiple isolated user space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132 as a single executable package of software that bundles application code together with all of the related configuration files, libraries, and dependencies required for it to run. Application 132 may be any software program, such as a word processing program.

In certain embodiments, computing system 100 can include a container orchestrator 177. Container orchestrator 177 implements an orchestration control plane, such as Kubernetes®, to deploy and manage applications and/or services thereof on hosts 102, of a host cluster, using containers 130. For example, Kubernetes may deploy containerized applications as containers 130 and a control plane on a cluster of hosts. The control plane, for each cluster of hosts, manages the computation, storage, and memory resources to run containers 130. Further, the control plane may support the deployment and management of applications (or services) on the cluster using containers 130. In some cases, the control plane deploys applications as pods of containers running on hosts 102, either within VMs or directly on an OS of the host. An example container-based cluster for running containerized workloads is illustrated in FIG. 1B. While the example container-based cluster shown in FIG. 1B is a Kubernetes cluster 150, in other examples, the container-based cluster may be another type of container-based cluster based on container technology, such as Docker® clusters.

As illustrated in FIG. 1B, Kubernetes cluster 150 is formed from a combination of one or more pods 140 including one or more containers 130, one or more kubelets 170, and a control plane 160. Further, although not illustrated in FIG. 1B, Kubernetes cluster 150 may include one or more kube proxies. A kube proxy is a network proxy that runs on each host 102 in Kubernetes cluster 150 that is used to maintain network rules. These network rules allow for network communication with pods 140 from network sessions inside and/or outside of Kubernetes cluster 150.

Kubelet 170 on each host 102 is an agent that helps to ensure that one or more pods 140 run on each host 102 according to a defined state for the pods 140, such as defined in a configuration file. Each pod 140 may include one or more containers 130.

Control plane 160 includes components such as an application programming interface (API) server 162, a cluster store (etcd) 166, a controller 164, and a scheduler 168. Control plane 160's components make global decisions about Kubernetes cluster 150 (e.g., scheduling), as well as detect and respond to cluster events (e.g., starting up a new pod 140 when a workload deployment's replicas field is unsatisfied).

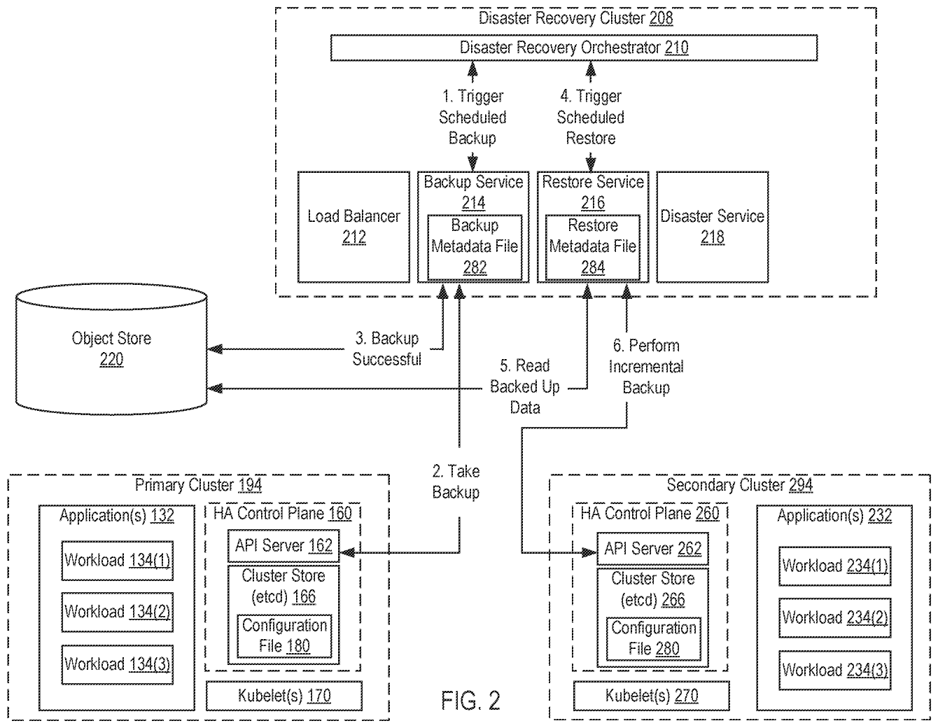

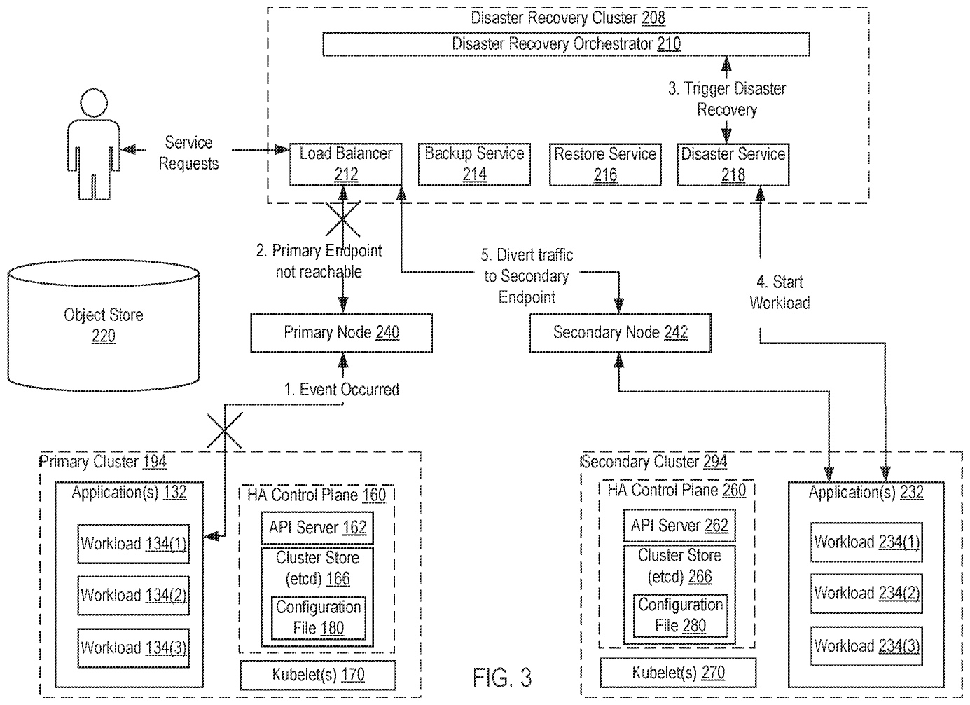

API server 162 operates as a gateway to Kubernetes cluster 150. As such, a command line interface, web user interface, users, and/or services communicate with Kubernetes cluster 150 through API server 162. According to aspects described herein, backup services, restore services, and/or disaster services may communicate with Kubernetes cluster 150 through API server 162. Backup services, restore services, and disaster services are described in detail below with respect to FIGS. 2 and 3. One example of a Kubernetes API server 162 is kube-apiserver. kube-apiserver is designed to scale horizontally—that is, this component scales by deploying more instances. Several instances of kube-apiserver may be run, and traffic may be balanced between those instances.

Cluster store (etcd) 166 is a data store, such as a consistent and highly-available key value store, used as a backing store for Kubernetes cluster 150 data. In certain aspects, cluster store (etcd) 166 stores a configuration file made up of one or more manifests that declare intended system infrastructure and workloads 134 (for application(s) 132) to be deployed in Kubernetes cluster 150. In certain aspects, the manifests are JavaScript Object Notation (JSON) and/or YAML files.

Controller 164 is a control plane 160 component that runs and manages controller processes in Kubernetes cluster 150. For example, control plane 160 may have (e.g., four) control loops called controller processes, which watch the state of Kubernetes cluster 150 and try to modify the current state of Kubernetes cluster 150 to match an intended state of Kubernetes cluster 150. In certain aspects, controller processes of controller 164 are configured to monitor external storage for changes to the state of Kubernetes cluster 150.

Scheduler 168 is a control plane 160 component configured to allocate new pods 140 to hosts 102. Additionally, scheduler 168 may be configured to distribute workloads, across containers 130, pods 140, and/or hosts 102 that are assigned to use resources of hardware platform 108. Resources may refer to processor resources, memory resources, networking resources, and/or the like. In some cases, scheduler 168 may schedule newly created containers 130 to one or more of the hosts 102.

In other words, control plane 160 manages and controls every component of Kubernetes cluster 150. Control plane 160 handles most, if not all, operations within Kubernetes cluster 150, and its components define and control Kubernetes cluster 150's configuration and state data. Control plane 160 configures and runs the deployment, management, and maintenance of the containerized applications 132. As such, ensuring high availability of the control plane may be critical to container deployment and management. High availability is a characteristic of a component or system that is capable of operating continuously without failing.

Accordingly, in certain aspects, control plane 160 may operate as a high availability (HA) control plane. Additional details of HA control planes are disclosed in U.S. Application Ser. No. 63/347,815, filed on Jun. 1, 2022, and titled “AUTONOMOUS CLUSTERS IN A VIRTUALIZATION COMPUTING ENVIRONMENT,” which is hereby incorporated by reference herein in its entirety.

As such, Kubernetes cluster 150, illustrated in FIG. 1B, provides a platform for running and managing containerized applications/workloads. Kubernetes cluster 150 is capable of scaling applications 132, as well as protecting containers 130 from failure. For example, Kubernetes helps to ensure that the actual state of Kubernetes cluster 150 and the desired state of cluster 150 are always in-sync via continuous monitoring within cluster 150. Whenever the state of cluster 150 changes from what has been defined (e.g., when a failure occurs), the various components of Kubernetes work to bring cluster 150 back to its defined state. This automated recovery is often referred to as self-healing.

While Kubernetes itself can protect the containers 130 that are running from failure, ensuring that the platform that's running Kubernetes is also protected may be critical. In particular, like many other cloud options, Kubernetes cluster 150 is not exempt from unplanned failures and/or downtime resulting from, for example, a network outage, hardware failure, loss of power due to a natural disaster, data breaches, and/or ransomware attacks. However, Kubernetes does not (nor do other container orchestration software) provide data protection and/or migration capabilities to bring the Kubernetes cluster 150, including its nodes, images, and containers, back online at a secondary site to resume normal operations. Accordingly, a disaster recovery plan that takes into consideration the architecture and constraints of container orchestration platforms, like Kubernetes, may be necessary to resume normal operations of a container-based cluster (e.g., Kubernetes cluster 150) at a secondary site in the event of failure and/or downtime.

Two indicators that may be considered as part of a disaster recovery plan include RTO and RPO. As mentioned herein, RTO is the length of downtime that may be allowed before recovery, and RPO is the threshold amount of data that may be lost during recovery. Optimally, both disaster recover parameters would be zero, which means no data loss and instant recovery when an event occurs.

According to aspects described herein, to achieve disaster recovery of containerized workloads with nearly zero RTO and RPO, incremental backup and incremental restore techniques are introduced to frequently backup and restore a state of a cluster at a secondary site, such that if an event occurs, the resources on the secondary site may be used to continue normal operations of the cluster. For example, a disaster recovery orchestrator cluster at a third site may be implemented with various services associated with disaster recovery, for example, backup services, restore services, disaster recovery services, and load balancing services. The backup services may be configured to frequently determine the change to a state of a cluster workload on a first site, since a previous backup activity was conducted. The restore services may be configured to frequently implement the change to the state of the workload at a secondary site. Implementing the change may include preparing resources at a secondary site to be able to continue operations for workloads of the first site should an event occur. In certain aspects, preparing resources at the secondary site involves obtaining pod and/or container image for pods and/or containers of the first site and storing these images on the secondary site. Further, in certain aspects, preparing resources at the secondary site includes deploying cluster workloads of the first site with zero replicas at the second site. Accordingly, by performing both the incremental backup and incremental restore, should an event occur, cluster workloads of the first site (e.g., which has failed) may be instantiated on the second site with nearly zero RTO and RPO. Example backup, restore, and disaster recovery services provided by the disaster recovery orchestrator cluster are described in more detail with respect to FIGS. 2 and 3.

For example, FIG. 2 illustrates example operations for the backup and restore of cluster resources, according to an example embodiment of the present disclosure. As illustrated in FIG. 2, a primary container-based cluster 194 (subsequently referred to herein as “primary cluster 194”) (e.g., such as Kubernetes cluster 150 illustrated in FIG. 1B) may be formed from a combination of one or more applications 132 and corresponding workloads 134, one or more kubelets 170, and a control plane 160. Primary cluster 194 may be running on a first site that is a set of one or more containers of one or more pods running on nodes in a first datacenter.

To prepare for instances where primary cluster 194 may go into an unrecoverable state (e.g., as the result of an event occurring), aspects of the present disclosure introduce a disaster recovery cluster 208. Disaster recovery cluster 208 includes services configured to perform backup, restore, and disaster recovery operations for primary cluster 194. In particular, services of disaster recovery cluster 208 may be used to frequently, and incrementally, backup and restore workloads 134 of primary cluster 194 (and the necessary architecture for running these workloads 134) at a secondary container-based cluster 294 (subsequently referred to herein as “secondary cluster 294”) deployed on a second site. The second site may be a set of one or more containers of one or more pods running on nodes in the first datacenter (e.g., where primary cluster 194 is running) or a second datacenter. Further, disaster recovery cluster 208 may be deployed on a third site, where the third site is a set of one or more containers of one or more pods running on nodes in the first datacenter, the second datacenter, or a third datacenter.

To perform backup and restore operations, for example, disaster recovery cluster 208 includes a disaster recovery orchestrator 210, backup service 214, and restore service 216. Disaster recovery cluster 208 also includes a load balancer 212 and a disaster service 218 for performing disaster recovery services, which are described in detail with respect to FIG. 3. Disaster recovery orchestrator 210 is configured to connect over a network to both primary cluster 194 and secondary cluster 294. Further, disaster recovery orchestrator 210 is configured to coordinate with backup service 214 and restore service 216 to (1) trigger backup service 214 to perform backup operations of primary cluster 194 and (2) trigger restore service 216 to perform restore operations of primary cluster 194 at secondary cluster 294.

For example, in certain aspects, disaster recovery orchestrator 210 is configured to receive a disaster recovery specification from a user. The disaster recovery specification received by disaster recovery orchestrator 210 may include information about primary cluster 194 and secondary cluster 294. Disaster recovery orchestrator 210 may use this information to connect over a network to primary cluster 194 and/or secondary cluster 294 for backup and restore of resources of primary cluster 194 on the first site to secondary cluster 294 on the second site.

In certain aspects, the disaster recovery specification received by disaster recovery orchestrator 210 further provides details about a backup schedule and/or a restore schedule for primary cluster 194. In some cases, the backup and/or restore schedules indicate a frequency of incremental backup and/or incremental restore to occur for primary cluster 194 (e.g., every thirty minutes). In some cases, the backup and/or restore schedules indicate that restore operations are to occur subsequent to performing backup operations (e.g., immediately after and incremental backup is performed), while in some other cases, the backup and/or restore schedules may indicate that backup and restore operations are to be performed concurrently. Disaster recovery orchestrator 210 may use information provided in the received disaster recovery specification to determine when to trigger backup service 214 and restore service 216 to perform incremental backup and restore of primary cluster 194.

For example, after receiving the disaster recovery specification, disaster recovery orchestrator 210 may create a backup schedule and a restore schedule for primary cluster 194. In accordance with the backup schedule, as shown at the first operation in FIG. 2, disaster recovery orchestrator may trigger backup service 214 to perform incremental backup of primary cluster 194.

In response to the trigger, backup service 214 may take a backup of primary cluster 194, at the second operation illustrated in FIG. 2, and, in some cases, store the backup data for primary cluster 194 in an object store 220, at the third operation illustrated in FIG. 2. More specifically, backup service 214 may determine a current state of primary cluster 194 and compare this state with a prior state of primary cluster 194 (e.g., obtained at a previously scheduled backup) to determine what modifications, if any, have been made to the state of primary cluster 194.

In certain aspects, to determine the current state of primary cluster 194, backup service 214 communicates with API server 162 of primary cluster 194. API server 162 then communicates with kubelet(s) 170 to determine a current state of primary cluster 194. Kubelet(s) 170 may access configuration file 180 stored in cluster store (etcd) 166 to determine the current state of primary cluster 194. In particular, configuration file 180 may be made up one or more manifests that define an intended state for infrastructure (e.g., pods, containers, etc.) and workloads deployed in primary cluster 194. API server 162 and kubelet(s) 170 or primary cluster 194 may communicate this information included in configuration file 180 to backup service 214.

Backup service 214 may compare the information included in configuration file 180 to information in a backup metadata file 282 maintained by backup service 214 to determine what modifications, if any, have been made to the state of primary cluster 194. In particular, backup metadata file 282 may include information about a previous state of primary cluster 194 determined during an immediately prior scheduled backup. In certain aspects, backup metadata file 282 may include hashes for objects which represent the state of primary cluster 194 from a previously scheduled backup. In certain aspects, to determine the delta between the current state of primary cluster 194 and the previously captured state of primary cluster 194, configuration file 180 is separated into a first plurality of chunks and a hash is calculated for each chunk. Hashes for chunks of the configuration file 180 may be compared to hashes of the backup metadata file 282 to determine the delta between configuration file 180 and backup metadata file 282 (e.g., determine the delta between the current state of primary cluster 194 and the previously captured state of primary cluster 194).

Backup service 214 may use the determined delta to resolve differences between backup metadata file 282 and configuration file 180 such that backup metadata file 282 includes the current state of primary cluster 194 (e.g., for purposes of a subsequent backup). Further, in certain aspects, backup service 214 may use the determined delta to create an object for storage in object store 220. The created object may be a persistent entity used to represent the change in the desired state of primary cluster 194 from a previously scheduled backup such that objects in object store 220 represent the current, desired state of primary cluster 194.

In certain aspects, in addition to triggering backup service 214 to perform backup operations for primary cluster 194, disaster recovery orchestrator may also trigger restore service 216 to perform incremental restore of primary cluster 194 as secondary cluster 294 (e.g., in accordance with a restore scheduled). Disaster recovery orchestrator 210 may trigger restore service 216 at the fourth operation as shown in FIG. 2.

In response to the trigger, restore service 216 may read backed up data stored for primary cluster 194 in object store 220, at the fifth operation illustrated in FIG. 2, and perform incremental restore of primary cluster 194 as secondary cluster 294, at the sixth operation illustrated in FIG. 2. More specifically, restore service 216 may determine a current state of primary cluster 194 based on objects stored in object store 220 and compare this state with a current state of secondary cluster 294 (e.g., created at a previously scheduled restore) to determine what modifications, if any, need to be made to the state of secondary cluster 294 such that the state of secondary cluster 294 is consistent with the current state of primary cluster 194. In certain aspects, restore service 216 may compare the current state of primary cluster 194 backed up in object store 220 to information in a restore metadata file 284 maintained by restore service 216 to determine what modifications (e.g., delta), if any, need to be made to the state of secondary cluster 294 to make the state of secondary cluster 294 consistent with the current state of primary cluster 194.

Restore service 216 may subsequently perform the incremental restore by making changes to the state of secondary cluster 294 (e.g., to match the state of primary cluster 194). In certain aspects, making changes to the state of secondary cluster 294 includes modifying resources defined in one or more manifest files of configuration file 280 stored in cluster store (etcd) 266 at secondary cluster 294. In certain aspects, resources of configuration file 280 are modified to update system infrastructure and workloads 234 of secondary cluster 294 such that the intended state of secondary cluster 294 matches the current state of primary cluster 194. Subsequently, the updated state of secondary cluster 294 may be implemented. In certain aspects, implementing the updated state involves obtaining pod and/or container images to be deployed in secondary cluster 294 and storing these images on the secondary site.

Further, in certain aspects, implementing the updated state involves deploying workloads 234 defined by configuration file 280 with zero replicas at the secondary site. For example, a particular workload 134 on primary cluster 194 may have several copies/instances instantiated in primary cluster 194 as different containers 130, such as for parallelization or load balancing. As an illustrative example, the particular workload 134 may be running as a first workload instance 134a, a second workload instance 134b, and a third workload instance 134c. To deploy a workload 234 on secondary cluster 294 similar to workload 134 on primary cluster 194 (e.g., having a same number of instances), workload 234 may be configured at secondary cluster 294 using the updated state without launching workload 234. More specifically, to configure workload 234 without launching workload 234, an indication of the number of instances of workload 134 that are running on the primary cluster 194 may be stored, at the secondary cluster.

For example, configuration file 180 at primary cluster 194 may be used to determine a number of instances of workload 134 running on primary cluster 194. In particular, configuration file 180 may include a nested replicas field of a spec field for workload 134 deployed in primary cluster 194. The nested replicas field, for workload 134, may indicate a number of instances of workload 134 instantiated in primary cluster 194. An example nested replicas field of a spec field for a workload 134 deployed in primary cluster 194 is provided below. The replicas value for workload 134 shown in the nested replicas field is equal to three. As such, three instances of workload 134 may be running in primary cluster 194.

```
apiVersion: apps/v1
kind: Deployment
metadata:
  name: nginx-deployment
  labels:
    app: nginx
spec:
  replicas: 3
  selector:
    matchlabels:
      app: nginx
        ...
```

Accordingly, when deploying a workload 234 in secondary cluster 294 (e.g., for backup and restore of workload 134 in primary cluster 194), the nested replicas field for workload 234 in configuration file 280, may be set to zero such that workload 234 is not launched at the time of deployment. However, in a replicas field of a nested annotations field of configuration file 280, the number of instances of workload 234 to be instantiated in secondary cluster 294 may be defined. Defining the number of instances for workload 234 in the annotations section of configuration file 280 may allow for easier startup of workload 234 (and their requested replicas) in secondary cluster 294 should an event occur causing failure and/or downtime of operations for primary cluster 194. In particular, the number of instances from the annotations section can be written to the replicas value in the replicas field, and accordingly, the control plane 260 will instantiate that number of instances of the workload 234 in secondary cluster 294.

Example information (e.g., contained in configuration file 280) for deployment of a workload 234 in secondary cluster 294, without starting the workload 234 in secondary cluster 294, is provided below.

```
apiVersion: apps/v1
kind: Deployment
metadata:
  annotations:
    replicas: “3”
  name: nginx-deployment
  labels:
    app: nginx
spec:
  replicas: 0
  selector:
    matchlabels:
      app: nginx
        ...
```

As shown, a replicas value of the nested replicas field of the spec field for workload 234 deployed in secondary cluster 294 is equal to zero. However, a replicas value defined for the nested annotations field of the metadata field of configuration file 280 for workload 234 is equal to three.

FIG. 3 illustrates example operations for disaster recovery of containerized workloads, according to an example embodiment of the present disclosure. More specifically, FIG. 3 illustrates example operations for recovery of containerized workloads 134 of primary cluster 194 as containerized workloads 234 on secondary cluster 294. Such recovery illustrated in FIG. 3 may be performed when primary cluster 194 goes into an unrecoverable state (e.g., as the result of an event occurring). Further, recovery of workloads 134 on primary cluster 194 as workloads 234 on secondary cluster 294 may be performed subsequent to one or more incremental backup and restore operations, described with respect to FIG. 2.

For example, as illustrated in the first and second operations of FIG. 3, when an event occurs, a primary node 240 where one or more workloads 134 of primary cluster 194 are running may not be reachable. As such, service requests from a user directed to one or more workloads 134 running in primary cluster 194 on primary node 240, by a load balancer 212, may not be serviced by workloads 134.

As mentioned above, disaster recovery cluster 208 may include a load balancer 212. Load balancer 212 may be configured to act as a traffic controller, routing user requests to the nodes capable of serving them quickly and efficiently. In certain aspects, load balancer 212 is further configured to help ensure high availability by sending user requests to pods of healthy clusters in the case of an event at another cluster. For example, load balancer may be configured to (1) determine when a node running a container-based cluster is not reachable, (2) inform disaster recovery orchestrator 210 about the identified node such that disaster recovery services may be triggered to instantiate the container-based cluster on another node, and (3) redirect traffic from users to the new node, after the container-based cluster is instantiated, such that normal operations may continue.

Accordingly, as illustrated in FIG. 3, when load balancer 212 determines that primary node 240 is not reachable, load balancer 212 may inform disaster recovery orchestrator 210. Disaster recovery orchestrator 210 may then trigger, at the third operation illustrated in FIG. 3, disaster recovery operations by a disaster service 218, also within disaster recovery cluster 208.

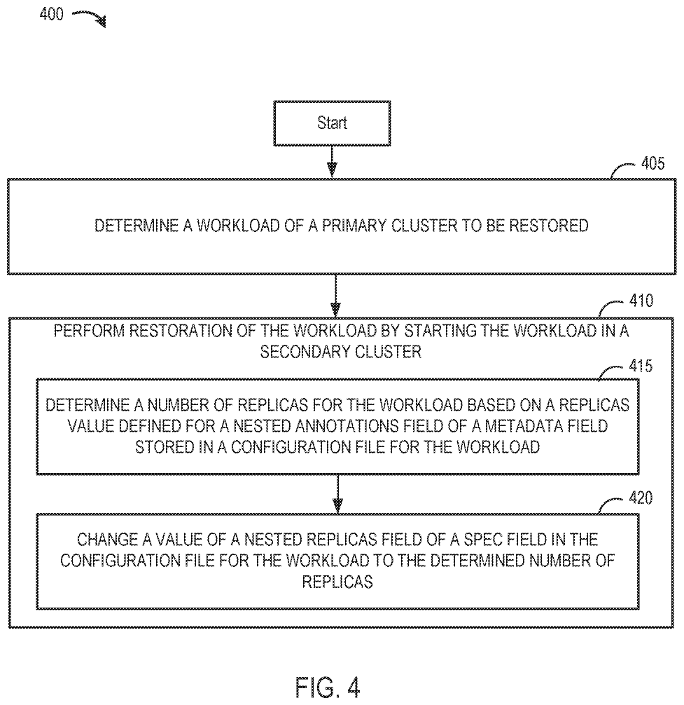

In response to the trigger, disaster service 218 may start workload(s) 234 in secondary cluster 294. In certain aspects, workload(s) 234 to be started may be workloads 234 which were previously deployed in secondary cluster 294 via backup and restore operations performed by backup service 214 and restore service 216 of disaster recovery cluster 208 (e.g., as described with respect to FIG. 2). As such, to start these workload(s) 234 on secondary cluster 294, disaster service 218 may update a value of a nested replicas field of a spec field for each workload 234 in configuration file 280 stored in cluster store (etcd) 266. Updating a replicas value for each workload 234 to start workloads 234 in secondary cluster 294 is described in more detail with respect to FIG. 4.

FIG. 4 is a flow diagram illustrating example operations 400 for starting a containerized workload 234 in secondary cluster 294, according to an example embodiment of the present disclosure.

Operations 400 begin, at block 405, by determining a workload 134 of primary cluster 194 to be restored. Operations 400 continue, at block 410, by starting the determined workload 134 in secondary cluster 294 as a workload 234, to perform restoration of workload 134.

In certain aspects, starting workload 234 in secondary cluster 294, at block 410, includes operations, at block 415, for determining a number of replicas for the workload 234 based on a replicas value defined for a nested annotations field of a metadata field in configuration file 280 for workload 234. Further, starting the determined workload 134 includes operations, at block 420, for changing a value of a nested replicas field of a spec field in configuration file 280 for workload 134 to the determined number of replicas.

For example, configuration file 280 may include the following information stored for workload 234 deployed in secondary cluster 294.

```
apiVersion: apps/v1
kind: Deployment
metadata:
  annotations:
    replicas: “3”
  name: nginx-deployment
  labels:
    app: nginx
spec:
  replicas: 0
  selector:
    matchlabels:
      app: nginx
        ...
```

Accordingly, to start workload 234 in secondary cluster 294, at block 415, a number of replicas for workload 234 may be determined to be equal to three, based on a replicas value of “3” defined for a nested annotations field of a metadata field in configuration file 280 for workload 234. Further, at block 420, a value of the nested replicas field of the spec field in configuration file 280 for workload 234 may updated to be equal to three, as shown below.

```
apiVersion: apps/v1
  kind: Deployment
  metadata:
    annotations:
      replicas: “3”
    name: nginx-deployment
    labels:
      app: nginx
  spec:
    replicas: 3
    selector:
      matchlabels:
        app: nginx
```

Setting a value of the nest replicas field equal to three may start three replications of workload 234 in secondary cluster 294. For example, control plane 260 may determine a change to the state of workload 234 (e.g., determine a change to a replicas value for workload 234 from zero to three) and therefore cause instantiation of workload 234 in secondary cluster 294. In certain aspects, a command line tool, referred to as kubectl in Kubernetes, apply application programming interface (API) is called, via API server 262, to cause instantiation of workload 234 in secondary cluster 294. More specifically, three instances of workload 234 may be instantiated in secondary cluster 294 based on the replicas value being set to three.

Similar operations may be performed for each workload 234 to be started in secondary cluster 294. As such, given startup of workloads 234 may require only changing a replicas value for each workload 234, RTO and/or RPO may be reduced when performing disaster recovery services. Further, because pod and/or container images for running workloads 234 were previously stored on the second site during backup and restore operations, obtaining such pod and/or container images may not be necessary and therefore contribute to reducing RPO and/or RTO as compared to existing solutions for disaster recovery of containerized workloads.

Returning to FIG. 3, after workload(s) 234 are started in secondary cluster 294, load balancer 212 may redirect service requests from a user to workloads 234 instantiated in secondary cluster 294 on a secondary node 242 to continue with normal operations.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for disaster recovery of a containerized workload running on a first host cluster, the method comprising:
prior to determining the containerized workload is unreachable at the first host cluster:
obtaining a current state of the containerized workload running on the first host cluster, the current state indicating a number of instances of the containerized workload that are running on the first host cluster;
storing one or more images associated with the containerized workload on a second host cluster; and
configuring the containerized workload at the second host cluster using the obtained current state without launching the containerized workload at the second host cluster, the configuring comprising storing, at the second host cluster, an indication of the number of instances of the containerized workload that are running on the first host cluster;
determining the containerized workload is unreachable at the first host cluster; and
instantiating one or more instances of the containerized workload in the second host cluster using the stored one or more images in response to determining the containerized workload is unreachable at the first host cluster, a number of the one or more instances being based on the number of instances of the containerized workload that were running on the first host cluster.

2. The method of claim 1, wherein configuring the containerized workload at the second host cluster using the obtained current state without launching the containerized workload at the second host cluster further comprises setting a replicas value of a replicas field of a configuration file, associated with the containerized workload at the second host cluster, to zero.

3. The method of claim 1, wherein the indication of the number of instances of the containerized workload that are running on the first host cluster is stored in an annotations section of a configuration file associated with the containerized workload at the second host cluster.

4. The method of claim 3, wherein instantiating the one or more instances of the containerized workload in the second host cluster comprises:
determining the number of instances of the containerized workload indicated in the annotations section of the configuration file at the second host cluster; and
setting a replicas value of a replicas field of the configuration file to the number of instances of the containerized workload.

5. The method of claim 1, wherein the one or more images associated with the containerized workload comprise at least one of:
pod images of one or more pods for running one or more containers used to deploy and run the containerized workload; or
container images of the one or more containers used to deploy and run the containerized workload.

6. The method of claim 1, further comprising:
determining a change from a previous state of the containerized workload running on the first host cluster to the current state,
wherein the containerized workload is configured at the second host cluster based on the change.

7. The method of claim 1, wherein:
the first host cluster is running on a first site that is a set of one or more first containers of one or more first pods running on one or more first nodes; and
the second host cluster is running on a second site that is a set of one or more second containers of one or more second pods running on one or more second nodes.

8. The method of claim 1, wherein the containerized workload is unreachable based on, at least one of:
a network outage;
a hardware failure;
a loss of power;
a data breach; or
a ransomware attack.

9. A system comprising:
one or more processors; and
at least one memory, the one or more processors and the at least one memory configured to:
prior to determining a containerized workload running on a first host cluster is unreachable at the first host cluster:
obtain a current state of the containerized workload running on the first host cluster, the current state indicating a number of instances of the containerized workload that are running on the first host cluster;
store one or more images associated with the containerized workload on a second host cluster; and
configure the containerized workload at the second host cluster using the obtained current state without launching the containerized workload at the second host cluster, the configuring comprising storing, at the second host cluster, an indication of the number of instances of the containerized workload that are running on the first host cluster;
determine the containerized workload is unreachable at the first host cluster; and
instantiate one or more instances of the containerized workload in the second host cluster using the stored one or more images in response to determining the containerized workload is unreachable at the first host cluster, a number of the one or more instances being based on the number of instances of the containerized workload that were running on the first host cluster.

10. The system of claim 9, wherein to configure the containerized workload at the second host cluster using the obtained current state without launching the containerized workload at the second host cluster further comprises to set a replicas value of a replicas field of a configuration file, associated with the containerized workload at the second host cluster, to zero.

11. The system of claim 9, wherein the indication of the number of instances of the containerized workload that are running on the first host cluster is stored in an annotations section of a configuration file associated with the containerized workload at the second host cluster.

12. The system of claim 11, wherein to instantiate the one or more instances of the containerized workload in the second host cluster comprises to:
determine the number of instances of the containerized workload indicated in the annotations section of the configuration file at the second host cluster; and
set a replicas value of a replicas field of the configuration file to the number of instances of the containerized workload.

13. The system of claim 9, wherein the one or more images associated with the containerized workload comprise at least one of:
pod images of one or more pods for running one or more containers used to deploy and run the containerized workload; or
container images of the one or more containers used to deploy and run the containerized workload.

14. The system of claim 9, wherein the one or more processors and the at least one memory are further configured to:
determine a change from a previous state of the containerized workload running on the first host cluster to the current state,
wherein the containerized workload is configured at the second host cluster based on the change.

15. The system of claim 9, wherein:
the first host cluster is running on a first site that is a set of one or more first containers of one or more first pods running on one or more first nodes; and
the second host cluster is running on a second site that is a set of one or more second containers of one or more second pods running on one or more second nodes.

16. The system of claim 9, wherein the containerized workload is unreachable based on, at least one of:
a network outage;
a hardware failure;
a loss of power;
a data breach; or
a ransomware attack.

17. A non-transitory computer-readable medium comprising instructions that, when executed by one or more processors of a computing system, cause the computing system to perform operations for disaster recovery of a containerized workload running on a first host cluster, the operations comprising:
prior to determining the containerized workload is unreachable at the first host cluster:
obtaining a current state of the containerized workload running on the first host cluster, the current state indicating a number of instances of the containerized workload that are running on the first host cluster;
storing one or more images associated with the containerized workload on a second host cluster; and
configuring the containerized workload at the second host cluster using the obtained current state without launching the containerized workload at the second host cluster, the configuring comprising storing, at the second host cluster, an indication of the number of instances of the containerized workload that are running on the first host cluster;
determining the containerized workload is unreachable at the first host cluster; and
instantiating one or more instances of the containerized workload in the second host cluster using the stored one or more images in response to determining the containerized workload is unreachable at the first host cluster, a number of the one or more instances being based on the number of instances of the containerized workload that were running on the first host cluster.

18. The non-transitory computer-readable medium of claim 17, wherein configuring the containerized workload at the second host cluster using the obtained current state without launching the containerized workload at the second host cluster further comprises setting a replicas value of a replicas field of a configuration file, associated with the containerized workload at the second host cluster, to zero.

19. The non-transitory computer-readable medium of claim 17, wherein the indication of the number of instances of the containerized workload that are running on the first host cluster is stored in an annotations section of a configuration file associated with the containerized workload at the second host cluster.

20. The non-transitory computer-readable medium of claim 19, wherein instantiating the one or more instances of the containerized workload in the second host cluster comprises:
determining the number of instances of the containerized workload indicated in the annotations section of the configuration file at the second host cluster; and
setting a replicas value of a replicas field of the configuration file to the number of instances of the containerized workload.
